(19) United States
(12) Patent Application Publication
(10) Pub. No.: US 2024/0069504 A1
(43) Pub. Date: Feb. 29, 2024

(54) METHOD AND APPARATUS FOR MINIMIZING A DEVIATION OF A PHYSICAL PARAMETER OF A BLOW-MOLDED CONTAINER FROM A TARGET VALUE

(71) Applicant: Krones AG, Neutraubling (DE)

(72) Inventors: Benedikt Boettcher, Bruckmühl (DE); Thomas Albrecht, Beilngries (DE); Bernhard Domeier, Pentling (DE); Ilona Krause, Neutraubling (DE)

(21) Appl. No.: 18/457,959

(22) Filed: Aug. 29, 2023

(30) Foreign Application Priority Data
Aug. 31, 2022 (DE) 102022121954.2

(51) Int. Cl. G05B 13/02; G06N 3/045

(52) U.S. Cl. CPC G05B 13/027; G06N 3/045

(57) ABSTRACT

A method for minimizing a deviation of a physical parameter of a blow-molded container from a target value comprises determining a physical parameter of a container assigned to a machine parameter value of a blow molding machine and an environmental condition, based on the physical parameter and the target value, determining a change in the machine parameter, based on an iteration process, determining an optimal machine parameter value for achieving a minimum deviation from the target value of the physical parameter of a blow-molded container, the iteration process comprising a first iteration step for determining a deviation from the target value of the physical parameter of a blow-molded container based on a change in the machine parameter value, and a second iteration step for determining an adjusted change in the machine parameter value based on the deviation of the physical parameter of a blow-molded container from the target value.

### CROSS-REFERENCE TO RELATED APPLICATION(S) AND CLAIM OF PRIORITY

This application claims priority to German Patent Application No. 102022121954.2, filed Aug. 31, 2022, the disclosure of which is incorporated herein by reference in its entirety.

### TECHNICAL FIELD

The invention relates to a method for minimizing a deviation of a physical parameter of a blow-molded container from a target value and to a corresponding apparatus.

### BACKGROUND

Blow molding has become established for the production of containers. In this case, a preform is first brought to a particular target temperature by means of a heating apparatus and subsequently transferred into a blow mold in which blowing air is then applied to the preform. By applying blowing air, the pre-tempered preform extrudes in the blow mold and adjusts to the contours thereof. Depending on the design of the blow mold, containers of a wide variety of shapes can thus be produced. In particular, containers of a small wall thickness can be produced by blow molding.

The quality of a blow-molded container can be assessed on the basis of the compressive strength along the longitudinal container axis, also referred to as top load, and on the basis of the compressive strength along the transverse container axis, also referred to as side load. The top load and the side load in turn depend on a wall thickness or a wall thickness distribution of the container. In order to produce containers of consistent quality, it is therefore desirable to produce containers of a wall thickness or a wall thickness profile that deviates as little as possible from a target wall thickness or a target wall thickness profile.

It is known from the prior art to metrologically acquire the wall thickness of containers after the blow molding process and to adjust a machine parameter of a blow molding machine based on the obtained data such that the deviation of the wall thickness from a specified target value is minimized.

EP1998950B1 discloses, for example, a method and an apparatus for determining the wall thickness of a container, wherein the wall thickness is measured after the blowing process, and a radiant heater for heating a preform before the blowing process is controlled based on the comparison between the measured value and a target value.

### SUMMARY

With regard to the prior art, the technical object of the present invention to be achieved is to improve the quality of blow-molded containers.

In order to achieve the object, the invention provides a method for minimizing a deviation of a physical parameter of a blow-molded container from a target value and a corresponding apparatus. Preferred embodiments of the invention are also set forth.

The method according to the invention for minimizing a deviation of a physical parameter of a blow-molded container from a target value comprises determining a physical parameter of a container assigned to a machine parameter value of a blow molding machine, based on the physical parameter and the target value, determining a change in a machine parameter value, based on an iteration process, determining an optimal machine parameter value for achieving a minimum deviation from the target value of the physical parameter of a blow-molded container, the iteration process comprising a first iteration step for determining a deviation from the target value of the physical parameter of a blow-molded container based on a change in the machine parameter value, and a second iteration step for determining an adjusted change in the machine parameter value based on the deviation of the physical parameter of a blow-molded container from the target value, obtaining the optimal machine parameter value; wherein the method furthermore comprises controlling the blow molding machine based on the obtained optimal machine parameter value.

Instead of directly adjusting a machine parameter based on a deviation of the physical parameter from a target value, wherein the adjusted machine parameter is clearly (deterministically) linked to the deviation from the target value, the method according to the invention determines, by means of an iteration process, an optimal machine parameter for minimizing the deviation and passes the determined optimal machine parameter to the machine. A previously known clear link between the deviation from the target value and the adjusted machine parameter, as is known from the prior art, is thus not present in the method according to the invention (not deterministically). By means of the iterative determination of the optimal machine parameter, a more precise and more efficient adjustment of the machine parameter for minimizing the deviation of the physical parameter from a target value in comparison to the prior art can be achieved, where the machine parameter is derived directly from the measured deviation of the physical parameter from the target value. The machine parameter in the sense of the invention is understood to mean a machine parameter of the blow molding machine that has an influence on the physical parameters of the container. For example, the machine parameter may be a heating power or a characteristic variable for the heating power of a heating apparatus for heating the preform, a switch-on duration of the heating apparatus, a temperature profile generated by the heating apparatus in the preform, a temperature of the preform heated by means of the heating apparatus, a pre-blowing pressure or blowing pressure, a pre-blowing pressure profile or a blowing pressure profile, a pre-blowing time or a blowing time, a temperature of a blow mold, a stretching speed, a stretching profile. The variable characteristic of the heating power can be a variable related to the heating power, such as a heating current or a voltage. However, the machine parameter is not limited to the examples just listed and may also be any other machine parameter that can influence the physical parameter of a container. It may be provided that the change in the machine parameter is initialized with a starting value before the iteration process is performed.

The method according to the invention is designed to minimize the deviation of a physical parameter of any blow-moldable container. Preferably, the blow-moldable container is a bottle which is used in the beverage industry and consists of plastic or comprises plastic. However, the apparatus is not limited to this type of container and may also be used, for example, for the production of cans, cups or tubes made of blow-moldable material, as are used in the food, beverage, pharmaceutical or health industry.

Optionally, in addition to determining a physical parameter of a container assigned to a machine parameter value of a blow molding machine, the determination of a disturbance variable may also be provided. In the following, any influence on the physical parameter of the container that is not caused directly by the operation of the machine and thus by the machine parameters discussed above is to be understood in principle as a disturbance variable. The disturbance variable may be an environmental condition, such as an ambient temperature, an ambient pressure, an ambient air humidity, a temperature and/or an air humidity of air supplied to the heating apparatus for tempering the preform or to a compressor for generating the pre-blowing pressure and/or blowing pressure. However, it may also be any other environmental condition that can influence the physical parameter of the container. The disturbance variable may also describe a property of a preform from which the container is produced. A property of a preform may, for example, be a material composition of the preform, or a property of the material of which the preform consists or which the preform comprises, such as a viscosity, a copolymer content, a moisture or crystallization degree, or the temperature of the preform after passing through the heating apparatus. However, it may also be any other, not explicitly listed disturbance variable insofar as it has an influence on the physical parameter of the container.

The physical parameter of the container is understood to mean a parameter that describes a physical property of the container. In particular, it may be a physical property of the container that can be changed by the blowing process. The physical parameter may, for example, be a wall thickness, a variable characteristic of the wall thickness, a bottom thickness, a variable characteristic of the bottom thickness, an offset injection point, a variable of an injection lens, wherein the injection lens represents the center of the injection point, or a molecular orientation of the container. The variable characteristic of the wall thickness or of the bottom thickness may, for example, comprise the proportion of an intensity of electron-magnetic radiation transmitted through a wall thickness or bottom thickness in an intensity of the electromagnetic radiation radiated into the bottom thickness or wall thickness. be of the container. The variable characteristic of the wall thickness or of the bottom thickness may generally also depend on other characteristic variables of the container, such as a material composition, in addition to the wall thickness or the bottom thickness. Since the variable characteristic of the wall thickness or of the bottom thickness can depend on various characteristic variables of the container, the measurement of the characteristic variable and the comparison thereof to a target value can be better suitable for assessing the quality of the container than the mere measurement of a wall thickness or bottom thickness. However, it may also be any other, not explicitly mentioned physical parameter of a container.

The target value of the physical parameter is to be understood as a specified value of the physical parameter. The specified value may, for example, be a value ascertained from product requirements. If, for example, a bottle is to have a particular strength, the wall thickness may, for example, be fixed at a particular value that achieves the desired strength. This value can then be used as the target value of the physical parameter.

In one embodiment, a predictive model can be used to determine the deviation from the target value of the physical parameter of a blow-molded container. The predictive model may be a trained and validated predictive model. The predictive model may be designed, for example, as a decision tree, as a random decision tree, as a reinforced decision tree, as a polynomial model with various orders and interactions or as a linear or non-linear ARX model. However, the predictive model is not limited to these examples, it may thus also be any other predictive model. For example, a physical model for determining the deviation from the target value of the physical parameter of a container may, alternatively, also be provided.

By using a predictive model, the influence of the change in the machine parameter and/or the disturbance variable on the physical parameter of a blow-molded container can be predicted precisely. In particular, a repeated readjustment on the machine for finding the optimal machine parameter can thus be avoided and a higher quality can thus be achieved even at higher container throughputs.

In a preferred embodiment, the predictive model may be a first neural network or may comprise a first neural network Like the predictive model, the neural network may be a trained and validated neural network. By selecting a neural network as a predictive model, it is possible to achieve an even more precise and more efficient prediction of the influence of the changes in the machine parameter and/or the optional disturbance variable on the physical parameter of a blow-molded container. Since the determination of optimal machine parameters ultimately requires the optimization of a parameter dependent on a multitude of influences, neural networks that have been trained in particular for this application by means of suitable training data can be used particularly advantageously here since neural networks can be used particularly advantageously for pattern recognition.

In one embodiment, the iteration process can be based on a reinforcement learning model and, in particular, on a deep reinforcement learning model. The reinforcement learning model is particularly suitable for finding an optimal strategy for minimizing the deviation of the physical parameter of the container from a target value. The efficiency of the method can thus be improved by using a reinforcement learning model. Alternatively, an evolutionary algorithm or another natural analog optimization method may also be provided for minimizing the deviation of the physical parameter from a target value.

In one embodiment, the reinforcement learning model may comprise a first component and a second component. By the interaction of the second component with the first component, the optimal machine parameter for minimizing the deviation of the physical parameter of a blow-molded container from a target value can be obtained. The first component of the reinforcement learning model is generally known as the environment, and the second component of the reinforcement learning model is generally known as the agent. The agent acts with the environment and carries out an action on the environment based on a state value obtained from the environment and on a reward. The goal of the agent is to maximize the reward by appropriately adjusting the action. Consequently, by adjusting or optimizing the change in the machine parameter (action) by means of the second component in cooperation with the first component, the optimal machine parameter can be found, by means of which the deviation of the physical parameter (reward) can be minimized and the quality of a blow-molded container can thus be improved.

In one embodiment, the first component of the reinforcement learning model may be a predictive model or a first neural network or may comprise a predictive model or a first neural network. By selecting the predictive model or the first neural network as the first component, a relationship between the machine parameter, the optional disturbance variable, and the deviation of the physical parameter can be reliably provided to the reinforcement learning model.

In one embodiment, the second component of the reinforcement learning model can comprise a third neural network or may consist of a third neural network. As already explained above, neural networks are particularly suitable since they can make precise predictions in a short time.

In one embodiment, the first iteration step for determining a physical parameter of a blow-molded container based on the change in the machine parameter can be performed by the predictive model or the first neural network, and the second iteration step for determining an adjusted change in a machine parameter value based on the deviation of the physical parameter from the target value can be performed by the third neural network.

In one embodiment, obtaining the optimal machine parameter value can be based on a determination of an optimal adjusted change based on a minimum deviation from the target value of the physical parameter from the set of deviations from the target value of the physical parameter.

In one embodiment, the physical parameter of the blow-molded container can be a variable characteristic of a wall thickness of the container, a wall thickness, a bottom thickness, a variable characteristic of the bottom thickness, and/or a molecular orientation, or may comprise them. The variable characteristic of the wall thickness or of the bottom thickness may, for example, comprise the proportion of an intensity of electromagnetic radiation transmitted through a wall thickness or bottom thickness in an intensity of the electromagnetic radiation radiated into the bottom thickness or wall thickness. The variable characteristic of the wall thickness or of the bottom thickness may depend not only on the wall thickness or bottom thickness of the container but also on other property of the container, such as a material composition of the container. The variable characteristic of the wall thickness, the wall thickness, the variable characteristic of the bottom thickness, the bottom thickness or the molecular orientation of a container can have a direct influence on the maximum top load or side load which can be exerted on a container, and thus allow a direct conclusion about the quality of the container. The minimization of a deviation of these parameters from a target value thus allows an improvement in the quality of a blow-molded container. Optionally, the physical parameter can also be an offset injection point or a variable of an injection lens, wherein the injection lens represents the center of the injection point.

In one embodiment, it may be provided to determine a disturbance variable in addition to the physical parameter of a container assigned to a machine parameter value of a blow molding machine. The disturbance variable may be an environmental condition and/or a property of a preform. Both the environmental condition and the property of a preform, wherein the property is, for example, the material composition thereof or a property of the material of which the preform consists or which the preform comprises, or a temperature of the preform after passing through a heating apparatus, are in direct relationship with the physical parameter of the container. Taking into account these two disturbance variables consequently improves the optimization process and leads to an improved quality of the blow-molded container.

According to the invention, a blow molding machine for producing containers is also provided. The blow molding machine comprises a sensor device and a control apparatus, wherein the sensor device is designed to determine a physical parameter of a container assigned to a machine parameter value of the blow molding machine and to pass the machine parameter value and the physical parameter to the control apparatus, wherein the control device is designed to, based on the physical parameter and a target value, determine a change in a machine parameter value, based on an iteration process, determine an optimal machine parameter value for achieving a minimum deviation from the target value of the physical parameter, the iteration process comprising a first iteration step for determining a deviation from the target value of the physical parameter of a blow-molded container based on a change in the machine parameter value, and a—second iteration step for determining an adjusted change in a machine parameter value based on the deviation of the physical parameter from the target value, obtaining the optimal machine parameter value, and wherein the control device is designed to control the blow molding machine based on the obtained optimal machine parameter value.

In one embodiment, it may be provided that a predictive model is used to determine the influence of a change in the machine parameter value and/or an optional disturbance variable on the physical parameter of a container, and the iteration process is based on a reinforcement learning model, wherein the reinforcement learning model comprises a first and a second component, and wherein the first component is the predictive model, which may be designed as a first neural network, and the second component comprises a third neural network. By using a predictive model or a neural network, the influence of the change in a machine parameter and/or an optional disturbance variable can be predicted precisely and efficiently. The use of a reinforcement learning model in turn allows an optimal strategy to be found for minimizing the deviation of the physical parameter of the container from a target value and thus for improving the quality of the blow-molded containers.

In a more specific embodiment, it may be provided that the sensor device comprises a sensor which is designed to determine the physical parameter of the blow-molded container. Optionally, the sensor device may comprise an additional sensor designed to determine a disturbance variable and/or a further additional sensor designed to determine the machine parameter value of the blow molding machine.

In a further embodiment, it may be provided that the sensor is designed to determine a variable characteristic of a wall thickness, a wall thickness, a variable characteristic of a bottom thickness, a bottom thickness, and/or a molecular orientation of a blow-molded container. The variable characteristic of the wall thickness or of the bottom thickness may, for example, comprise the proportion of an intensity of electromagnetic radiation transmitted through a wall thickness or bottom thickness in an intensity of the electromagnetic radiation radiated into the bottom thickness or wall thickness. The variable characteristic of the wall thickness or of the bottom thickness may also depend on other physical parameters of the container, such as a material composition. The sensor for determining a variable characteristic of the wall thickness or of the bottom thickness may, for example, be an ultrasonic sensor or a spectroscopic sensor, which is designed to determine a proportion of an intensity of electromagnetic radiation transmitted through a wall thickness or bottom thickness in an intensity of the electromagnetic radiation radiated into the bottom thickness or wall thickness. For determining the molecular orientation of the container, a spectroscopic sensor may in turn be provided. The variable characteristic of the wall thickness, the wall thickness, the variable characteristic of the bottom thickness, the bottom thickness, and/or the molecular orientation can be directly related to the compressive strength along the longitudinal container axis and transverse to the transverse container axis. The precise metrological determination thereof by means of a suitable sensor is thus advantageous in order to be able to assess the quality of the container precisely.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a method for minimizing a deviation of a physical parameter of a blow-molded container according to one embodiment;

FIG. 2 illustrates a reinforcement learning model according to one embodiment; and

FIG. 3 illustrates a blow molding machine designed to minimize a physical parameter of a blow-molded container according to one embodiment.

### DETAILED DESCRIPTION

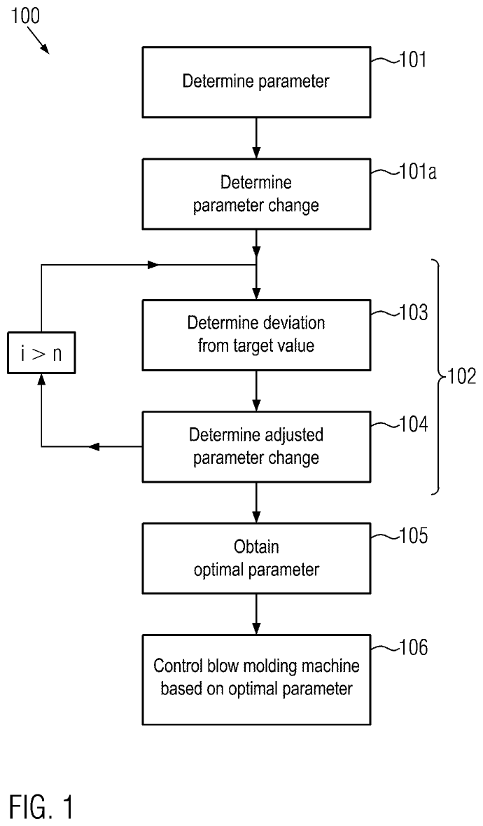

FIG. 1 shows a flow chart of the method 100 for minimizing a deviation of a physical parameter of a blow-molded container from a target value according to one embodiment.

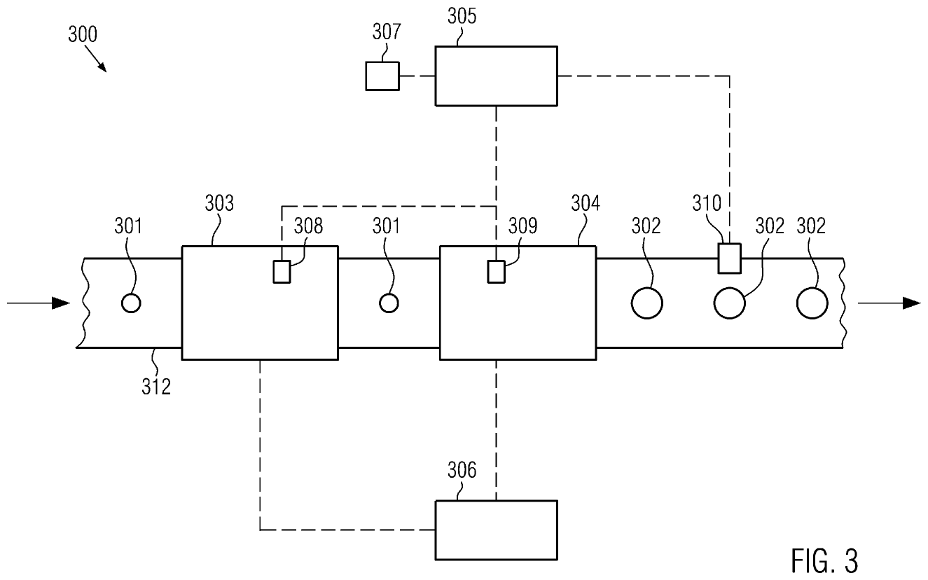

For producing the containers, a blow molding machine is provided, wherein the physical properties of the container can be influenced by varying a machine parameter of the blow molding machine. Optionally, other disturbance variables, such as an environmental condition or a property of the preform from which the container is produced, can also influence the physical properties of the container. A blow molding machine, which is designed to perform the method according to FIG. 1, is described in connection with FIG. 3.

The aim of the method described in the embodiment of FIG. 1 is to specify a model by means of which the deviation of the physical parameter (e.g., a variable characteristic of the wall thickness or of the bottom thickness of a container) of a blow-molded container from a target value can be kept as low as possible by the targeted adjustment of a machine parameter. Optionally, the model may be designed to keep the deviation of the physical parameter as low as possible by the targeted adjustment of the machine parameter, even in the case of changing conditions (disturbance variables).

The machine parameter may, for example, be a heating power of a heating apparatus for heating the preform, a switch-on duration of the heating apparatus, a temperature profile generated by the heating apparatus in the preform, a pre-blowing pressure or blowing pressure, a pre-blowing pressure profile or a blowing pressure profile, a pre-blowing time or a blowing time, the temperature of a blow mold, and/or a stretching speed.

In the following, any influence on the physical parameter of the container that is not caused directly by the operation of the machine and thus by the machine parameters discussed above is to be understood in principle as a disturbance variable. The term “physical parameter” may, for example, also be understood to mean a variable characterizing the physical parameter of a container, such as an optical parameter which may, for example, be a proportion of an intensity of electromagnetic radiation transmitted through a wall thickness or bottom thickness in an intensity of the electromagnetic radiation radiated into the bottom thickness or wall thickness, or a variable of the injection lens measured by means of image processing. The disturbance variable may be an environmental condition or a property of the preform from which the container is produced. The environmental condition may, for example, be an ambient temperature, an ambient air humidity, or an ambient pressure. The property of the preform may, for example, be a material composition of the preform or a material property of the preform, such as a viscosity, a copolymer content, a moisture or crystallization degree.

In the following, the target value indicates the value of the physical parameter to be obtained during the production of the container.

In the first method step 101, a physical parameter of a container, which is assigned to a particular machine parameter of a blow molding machine, is determined. Optionally, a disturbance variable assigned to the machine parameter of the blow molding machine may also be determined. For this purpose, for example, the machine parameter of the blow molding machine can be set to a particular target value and can be acquired after reaching the target value of the physical parameter of a container and metrologically. Optionally, metrologic ally acquiring a disturbance variable may also be provided.

In one embodiment, the change in the machine parameter value 101a is initialized with a starting value before the start of the iteration process 102. The starting value of the change in the machine parameter value is determined based on the physical parameter determined in the first method step 101 and on a target value for the physical parameter. For example, the change in the machine parameter value can be determined based on a difference between the target value and the metrologically acquired value of the physical parameter.

In the subsequent step 102, based on an iteration process, an optimal machine parameter is determined based, where applicable, on the physical parameter and the optional disturbance variable, by means of which optimal machine parameter a minimum deviation from the target value of the physical parameter of a blow-molded container can be achieved. The iteration process comprises two iteration steps 103 and 104. In the first iteration step 103, a deviation from the target value of the physical parameter of a blow-molded container is determined based on a change in the machine parameter, taking into account the disturbance variable(s) where applicable. The starting value may, for example, be determined by means of a neural network which determines the starting value based on the physical parameter, machine parameter, and disturbance variable determined metrologically in the first method step 101. The neural network is preferably an already trained or learned neural network which has been trained specifically with data/information suitable for determining the change in the machine parameters. In particular, the training/learning of the neural network can take place by means of an automated design of experiments (DOE) in which various machine parameter values are approached in an automated manner and an assigned physical parameter of a container and a disturbance variable are acquired metrologically.

In the second iteration step 104, an adjusted change in a machine parameter is determined based on the deviation of the physical parameter of a blow-molded container from a target value determined in the first iteration step 103. The adjusted change in the machine parameter determined by the second iteration step 104 is subsequently provided as an input to the first iteration step 103, in which a new deviation from the target value of the physical parameter is determined based on the adjusted change in the machine parameter value. On the basis of this new determined deviation from the target value of the physical parameter, an adjusted change in the machine parameter value is then again determined in the second iteration step, taking into account the disturbance variables where applicable.

A previously defined, stationary limit value n can specify after how many iteration steps the iteration process is ended. n is, for example, a whole number greater than zero but may also assume any other value, provided that a comparison to a consecutive index of iteration steps is possible. In a preferred embodiment, n may be a value of 10. Alternatively, a lower or higher value for n, for example 3, 5, 20, 50, or 100, may also be provided. Any other number is also conceivable, wherein the number of iteration steps can preferably be selected such that the time necessary to carry out all n iteration steps is, if possible, below a limit value T. T may, for example, be selected depending on the throughput or the response time of the blow molding machine in order to ensure that an adjustment of the machine parameter takes place, if possible, before further containers have been molded. For example, n may be selected such that T<50 ms or T<100 ms.

Alternatively, a dynamic limit value is also conceivable which is determined dynamically during the iteration process. It may be provided, for example, that the iteration process is only ended if the change in the deviation of the physical parameter from the target value over a number of i iteration steps is less than a specified limit value and/or if the deviation of the target value over a number of i iteration steps is below a limit value d specified, for example, by the production accuracy to be achieved. In such a case, the physical parameter already converges toward the target value and further calculations improve the result only to a degree irrelevant to the production accuracy to be achieved, so that further iterations can indeed improve the result but are no longer decisive for the accuracy of the products to be achieved.

Based on the adjusted changes in the machine parameter determined by the iteration process, an optimal machine parameter can finally be obtained 105.

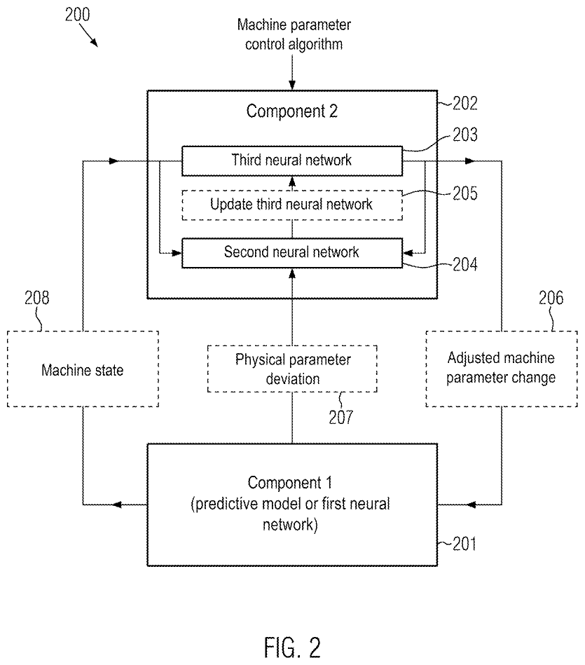

In one embodiment, it may be provided that the iteration process 102 is based on a reinforcement learning model. The reinforcement learning model comprises two components, based on the interaction of which the optimal machine parameter for minimizing the deviation of the physical parameter of a blow-molded container from a target value can be obtained. In a further embodiment, it may be provided that the first component comprises a predictive model or a first neural network, and the second component comprises a third neural network. The first component can be designed to determine a deviation of a physical parameter from a target value based on a change in a machine parameter. The second component can in turn be designed to determine an adjusted change in a machine parameter in order to minimize the deviation of the physical parameter determined by the first component. The third neural network may be a neural network trained by means of reinforcement learning. The training process of the third neural network by means of the reinforcement learning model is described in more detail in connection with FIG. 2.

In a further embodiment, it may be provided that obtaining the optimal machine parameter 105 is based on the determination of an optimal adjusted change, which in turn is based on a minimum deviation from the target value of the physical parameter from the set of the determined deviations from the target value of the physical parameter. The determination of the optimal adjusted change may, for example, comprise that the index m for which the deviation of the physical parameter from the target value is minimal is determined from the set of all iteratively determined deviations of the physical parameter from the target value and the adjusted machine parameters linked thereto. The optimal adjusted changes can be determined by means of summation over all adjusted changes with indices 1 . . . m. The optimal machine parameter can be obtained based on the optimal adjusted change determined in this way.

The optimal machine parameter can subsequently be passed 106 to the blow molding machine.

In one embodiment, it may be provided that code that can be executed for the first and the second component is generated in order to perform the iteration process during operation of the blow molding machine by means of a control unit of the blow molding machine, which may comprise a CPU and a GPU. It may be provided that the executable code is executed by the CPU of the control unit and/or by the GPU of the control unit.

FIG. 2 shows a training process of the third neural network based on a reinforcement learning model 200. By the interaction with the first neural network, as described in connection with FIG. 1, the trained third neural network can subsequently determine an optimal machine parameter for minimizing the deviation of the physical parameter from a target value. The reinforcement learning model 200 comprises a first 201 and a second component 202, which interact with one another. The first component 201 may be a predictive model or a first neural network or may comprise a predictive model or a first neural network. The predictive model may be designed, for example, as a decision tree, as a random decision tree, as a reinforced decision tree, as a polynomial model with various orders and interactions or as a linear or non-linear ARX model. In a preferred embodiment, it is a trained predictive model or a trained first neural network that has been specifically trained with data/information suitable for determining the deviation of the physical parameter based on a change in a machine parameter. The first component 201 of the reinforcement learning model thus establishes a relationship between the machine parameter, the disturbance variable and the deviation of the physical parameter of a container from a target value. As has already been explained in connection with FIG. 1, the first component 201 is consequently designed to predict the influence of a change in the machine parameter and/or the disturbance variable on the physical parameters of a container. In the reinforcement learning field, the first component is also known as the environment and the second component as the agent.

The first component 201 provides the second component 202 with information 207, 208, which is processed by the second component 202. Based on the processing information, the second component 202 generates an output 206, which is in turn provided to the first component 201. In the embodiment described here, the first component provides the second component with a state of the blow molding machine 208 and a deviation of the physical parameter from a target value 207. The aim of the iteration process is to minimize the deviation of the physical parameter 207. For this purpose, the second component 202 generates an adjusted change in a machine parameter value 206 based on the input 207, 208 provided. This value is in turn passed to the first component 201 and, based on the adjusted change in the machine parameter value, the first component 201 determines a deviation of the physical parameter from a target value assigned to this adjusted change, and a machine state. The first component 201 transmits the values determined in this way to the second component 202. It may be provided that the iteration process just described is repeated n times before it is ended. Alternatively, it may also be provided to end the iteration process only if the change in the deviation from the target value over a number of i iteration steps is less than a specified limit value.

In order to determine the adjusted change in the machine parameter value 206 based on the deviation of the physical parameter from a target value 207 obtained from the first component, and the machine state 208, the second component 202 comprises a second neural network 204 and a third neural network 203. In a preferred embodiment, the second neural network is a trained neural network which is designed to establish a relationship between the machine state 208 transmitted by the first component 201, the deviation of the physical parameter from a target value 207, and the adjusted change in the machine parameter 206. In addition, the second neural network is designed to update the third neural network based on the information 206, 207 obtained from the first component, so that said third neural network determines a new adjusted change in the machine parameter. The second neural network 204 can be designed as a reinforcement learning algorithm. The third neural network 203 is designed to respond, by means of an adjusted change in the machine parameter 206, to the deviation of the physical parameter from a target value 207 in order to minimize the deviation of the physical parameter from a target value.

After completion of the training process, the first neural network of the first component 201 and the third neural network 203 of the reinforcement learning model described in FIG. 2 can be used, according to the embodiment described in FIG. 1, in a blow molding machine. The second neural network 204 of the second component 203 is provided only for the above-described training process of the third neural network 203. The method described in FIG. 1 for minimizing the deviation of a physical parameter from a target value we preferably performed based only on the interaction of the first neural network of the first component 201 and the fully trained third neural network 203 of the second component 202. For this purpose, it may in particular be provided that, after completion of the described training, only the first neural network and the third neural network are implemented in the blow molding machine.

For this purpose, the first component 201 passes the determined deviation of the physical parameter 207 and the state of the machine 208 directly to the trained third neural network 203 without said deviation and said state being previously processed by the second neural network 204. The third neural network 203 then determines, directly on the basis of the parameters obtained from the first component 201, an adjusted change in the machine parameter 206, which is again passed to the first component 201. As already described in connection with FIG. 1, this iteration process can be carried out until a static limit value n is reached or until the change in the deviation of the physical parameter from the target value over a number of i iteration steps is less than a specified limit value and/or if the deviation of the target value over a number of i iteration steps is below a limit value d specified, for example, by the production accuracy to be achieved. Based on the iteratively determined adjusted change in the machine parameter 206, the optimal machine parameter 105 described in connection with FIG. 1 can ultimately be obtained, which can then be transmitted to the blow molding machine. Based thereon, a machine parameter of the blow molding machine can be set 106, and a container that has a minimum deviation of a physical parameter from a target value can be produced.

FIG. 3 shows a blow molding machine 300 for producing containers 302 from preforms 301. The blow molding machine shown in FIG. 3 is designed to carry out a method according to the embodiments described in FIGS. 1 and 2.

The blow molding machine according to the embodiment shown in FIG. 3 comprises a sensor device 305, a control apparatus 306, optionally a device 303 for pre-treating the preforms, and a blow molding device 304. In the embodiment shown here, the optional device 303 for pre-treating the preforms is arranged upstream of the blow molding device 304. The preforms 301/containers 302 can be transported by means of one or more transport apparatuses 312 through the blow molding machine 300.

For reasons of clarity, the transport apparatus 312 is shown as a linear transport apparatus. In an alternative embodiment, the preforms/containers can also be conveyed through the blow molding machine by means of one or more rotary units, in particular transport star-wheels, which can transport the preforms and/or containers, for example in the neck-handling method. For example, it may be provided that the optional device 303 for pre-treating the preforms is arranged along the circumference of a first rotary unit, and the blow molding device 304 is arranged along the circumference of a second rotary unit. According to the embodiment described above with a linear transport apparatus, the two rotary units are also arranged in such a way that the first rotary unit is arranged upstream of the second rotary unit.

At the beginning, the preforms 301 are optionally supplied to the apparatus for pre-treating 303. The pre-treatment device 303 may be a heating apparatus by means of which the preforms can be heated to a particular target temperature. This may be realized, for example, by means of one or more heating lamps which may be designed, for example, as infrared lamps. The heating apparatus may also be designed to produce a particular temperature profile so that the temperature of the preform is described not only by a temperature but by a temperature profile (e.g., along the length of the preform).

In a preferred embodiment, electromagnetic radiation, such as microwave radiation, is applied to the preform for heating. In doing so, the electromagnetic field responsible for heating the preform is influenced by advanceable functional units (e.g., slides) in such a way that a particular temperature profile can be generated on the preform by means of the electromagnetic field. The functional units can be controlled via a control unit 306. In particular, a resonator which is designed to generate electromagnetic radiation of a particular field strength distribution and can be controlled by means of the control unit 306 may be provided for generating the temperature profile in the preform. By applying the electromagnetic field generated by the resonator at a specified field strength distribution to the preform, a particular temperature distribution can be generated in the preform. The control apparatus 306 for controlling the functional units or the resonator can be connected to a sensor device 305. Thus, the control apparatus 306 can evaluate the state of the container by means of the data obtained from the sensor device 305, wherein the data may, for example, be the physical parameter of the container, and can, if necessary, adjust the temperature profile of the preform by controlling the functional units or the resonator, in such a way that the container corresponds to the required quality criteria.

In an alternative preferred embodiment, the apparatus for pre-treating 303 is designed as a laser heater. In this embodiment too, it may be provided that based on the data ascertained by the sensor device 305, the control apparatus 306 can adjust parameters of the laser heater, such as a power, a pulse duration, a repetition rate, a wavelength, a coherence length, a polarization, a beam diameter, an energy density, a beam profile, a divergence, or a spot size, in this way in order to produce a particular temperature profile in the preform. The laser heater can thus be controlled by the control apparatus 306 based on the data determined by the sensor device 305, which data may, for example, comprise the physical parameter of the container, in order to produce a particular temperature profile in the container so that containers with the required quality criteria can be manufactured.

The heated preforms 301 are subsequently transported into the blow molding device 304. The blow molding device preferably comprises a blow mold and an apparatus for applying blowing air to the preform. In the blow molding apparatus, the heated preforms are transferred into a blow mold and blowing air is applied to them, which leads to an extrusion of the preforms in the blow mold.

The blow molding device may be a stretch blow molding device or an extrusion blow molding apparatus. In stretch blow molding, in addition to the extrusion of the preform with blowing air, stretching in the longitudinal direction is carried out by inserting a stretching rod. In the case of extrusion blow molding, only blowing air is applied to the preform in order to cause the container to be molded in the mold.

After the blowing process, the container is removed from the blow mold. Optionally, it may be provided that the container is guided through a cooling device.

In order to assess the quality of a blow-molded container, a deviation of a physical parameter of the container is subsequently determined by means of a sensor device 305. In one embodiment, the device can be designed to determine a variable characteristic of the wall thickness of a container, a wall thickness, a variable characteristic of the bottom thickness, a bottom thickness, and/or a molecular orientation of the container. The variable characteristic of the wall thickness, the wall thickness, the variable characteristic of the bottom thickness, the bottom thickness, and/or the molecular orientation of a container are directly related to the maximum top load and side load of a container and are thus particularly suitable parameters for assessing the quality of a blow-molded container.

The sensor device 305 is also designed to determine at least one machine parameter of the blow molding machine and/or of the device for pre-treating the preforms. Alternatively, the machine parameters may also be stored in a memory of a control apparatus 306, which is designed to control the blow molding machine. In this case, a metrological determination of the machine parameters by the sensor device 305 is not necessary and the at least one machine parameter can be obtained, for example, from the memory. This is also to be understood as a determination of a machine parameter. Optionally, the sensor device 305 may be designed to measure at least one disturbance variable.

In one embodiment, the sensor device can comprise a first sensor for determining a machine parameter 308, 309, a second sensor for measuring a deviation of a physical parameter of a container 310, and a third sensor for measuring a disturbance variable 307. The machine parameter and the disturbance variable are parameters which have a direct influence on the physical parameters. The disturbance variable may, for example, be an environmental condition or a property of the preform from which the container is produced. The second sensor may, for example, be an ultrasonic sensor or a spectroscopic sensor for measuring a variable characteristic of a wall thickness of a container, a wall thickness, a variable characteristic of a bottom thickness of a container, a bottom thickness of a container, or a spectroscopic sensor for measuring a molecular orientation of the container. The spectroscopic sensor for measuring the variable characteristic of the wall thickness or of the bottom thickness may, for example, be designed to determine a proportion of an intensity of electromagnetic radiation transmitted through a wall thickness or bottom thickness in an intensity of the electromagnetic radiation radiated into the bottom thickness or wall thickness. In addition to the wall or the bottom thickness, the variable characteristic of the wall thickness or of the bottom thickness can also depend on other characteristic variables of the container, such as a material composition. Since the variable characteristic of the wall thickness or of the bottom thickness can depend on various characteristic variables of the container, the measurement of the characteristic variable and the comparison thereof with a target value is better suited for assessing the quality of the container than the mere measurement of a wall thickness or bottom thickness. The third sensor for measuring a disturbance variable may, for example, be a sensor for measuring an environmental condition. This may, for example, be a temperature sensor, an air humidity sensor, or a pressure sensor. The third sensor for measuring a disturbance variable may also be designed as a sensor for measuring a property of the preform. For example, the sensor may be a spectroscopic sensor for determining a material composition or a crystallization degree of a preform. The sensor device 305 is also designed to pass the metrologically acquired data to a control apparatus 306.

The control apparatus 306 is designed to perform the method described in FIGS. 1 and 2 according to any of the embodiments described in this context. The control apparatus may be directly assigned to the blow molding machine. It may however also be an external control apparatus. In principle, the control apparatus can be designed as a computer or server.

The control apparatus 306 is in particular designed to determine the influence of a change in the machine parameter value and/or a disturbance variable on the physical parameter of a container based on an iteration process. By means of the iteration process, the control apparatus 306 can determine an optimal machine parameter value for achieving a minimum deviation from the target value of the physical parameter. In a first iteration step, the control apparatus 306 determines a deviation from the target value of the physical parameter of a blow-molded container based on a change in the machine parameter. In one embodiment, it may be provided that the change in the machine parameter of the control apparatus is transferred before the start of the iteration process and that it is initialized with a starting value. In a second iteration step, the control apparatus 306 determines an adjusted change in a machine parameter value based on the determined deviation of the physical parameter from the target value. In order to perform the iteration process, the control apparatus can comprise the two neural networks described in connection with FIG. 1. Based on the adjusted change determined by the iteration process, the control apparatus can obtain an optimal machine parameter based on which the control device controls the blow molding machine in order to minimize the deviation of the physical parameter of the container from a target value.

1. A method for minimizing a deviation of a physical parameter of a blow-molded container from a target value, the method comprising:
determining a physical parameter of a container assigned to a machine parameter value of a blow molding machine;
based on the physical parameter and the target value, determining a change in the machine parameter;
based on an iteration process, determining an optimal machine parameter value for achieving a minimum deviation from the target value of the physical parameter of a blow-molded container, the iteration process comprising:
a first iteration step for determining a deviation from the target value of the physical parameter of a blow-molded container based on the change in the machine parameter value; and
a second iteration step for determining an adjusted change in the machine parameter value based on the determined deviation of the physical parameter of a blow-molded container from the target value;
obtaining the optimal machine parameter value; and
controlling the blow molding machine based on the obtained optimal machine parameter value.

2. The method of claim 1, wherein a predictive model is used to determine the deviation from the target value of the physical parameter of a blow-molded container.

3. The method of claim 2, wherein the predictive model comprises a first neural network.

4. The method of claim 3, wherein the iteration process is based on a reinforcement learning model.

5. The method of claim 4, wherein the reinforcement learning model comprises a first component and a second component, and wherein by an interaction of the first component with the second component, the optimal machine parameter for minimizing the deviation of the physical parameter of the blow-molded container from the target value is obtained.

6. The method of claim 5, wherein the first component of the reinforcement learning model comprises the predictive model.

7. The method of claim 6, wherein the second component of the reinforcement learning model consists of a third comprises a third neural network.

8. The method of claim 7, wherein the first iteration step is performed by the first neural network, and the second iteration step is performed by the third neural network.

9. The method of claim 1, wherein obtaining the optimal machine parameter value includes determining an optimal adjusted change based on the minimum deviation from the target value of the physical parameter from a set of deviations from the target value of the physical parameter.

10. The method of claim 9, wherein the physical parameter of the blow-molded container comprises a wall thickness, a variable characteristic of the wall thickness, a bottom thickness, a variable characteristic of the bottom thickness, and/or a molecular orientation.

11. The method of claim 9, wherein, in addition to determining the physical parameter of the container assigned to the machine parameter value of the blow molding machine, the method further comprises determining a disturbance variable, wherein the disturbance variable is an environmental condition and/or a property of a preform.

12. A blow molding machine for producing containers, comprising:
a sensor device; and
a control apparatus,
wherein the sensor device is configured to determine a physical parameter of a container assigned to a machine parameter value of the blow molding machine and to pass the machine parameter value and the physical parameter to the control apparatus,
wherein the control apparatus is configured to:
based on the physical parameter and a target value, determine a change in the machine parameter value;
based on an iteration process, determine an optimal machine parameter value for achieving a minimum deviation from the target value of the physical parameter, wherein the iteration process comprises:
a first iteration step for determining a deviation from the target value of the physical parameter of a blow-molded container based on the change in the machine parameter value; and
a second iteration step for determining an adjusted change in the machine parameter value based on the deviation of the physical parameter from the target value;
obtaining the optimal machine parameter value; and
control the blow molding machine based on the obtained optimal machine parameter value.

13. The blow molding machine of claim 12, wherein:
a predictive model is provided for determining the deviation from the target value of the physical parameter of a container;
the iteration process is based on a reinforcement learning model;
the reinforcement learning model comprises a first and a second component;
the first component is the predictive model and comprises a first neural network; and
the second component comprises a second and a third neural network.

14. The blow molding machine of claim 12, wherein the sensor device comprises a sensor configured to determine the physical parameter of the blow-molded container.

15. The blow molding machine of claim 14, wherein the sensor is configured to determine a wall thickness, a variable characteristic of the wall thickness, a bottom thickness, a variable characteristic of the bottom thickness, and/or a molecular orientation of a blow-molded container.

16. The method of claim 2, wherein the predictive model is a first neural network.

17. The method of claim 5, wherein the first component of the reinforcement learning model is the predictive model.

18. The method of claim 5, wherein the first component of the reinforcement learning model is the first neural network or comprises the first neural network.

19. The method of claim 6, wherein the second component of the reinforcement learning model consists of a third neural network.

20. The method of claim 7, wherein the first iteration step is performed by the predictive model, and the second iteration step is performed by the third neural network.
